(19) United States
(12) Patent Application Publication
(10) Pub. No.: US 2009/0279985 A1
(43) Pub. Date: Nov. 12, 2009

(54) FIXING UNIT

(75) Inventors: CHIEH-HSUAN LEE, Tu-Cheng (TW); YAW-SHEN LAI, Tu-Cheng (TW); CHAU-LIN CHANG, Tu-Cheng (TW); CHIEN-YU CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/177,108

(22) Filed: Jul. 21, 2008

(30) Foreign Application Priority Data
May 9, 2008 (CN) 200810301507.5

(51) Int. Cl. F16B 37/08

(52) U.S. Cl. 411/433

(57) ABSTRACT

A fixing unit that includes a sleeve assembly defining a through hole along an axis thereof, and an assembly slidably received in the through hole. The assembly includes first and second end. An elastic claw extends from the first end. The second end can be actuated by a user. The elastic claw is biased towards an open state. The fixing unit moves between a first and a second position. In the first position, the elastic claw is received in the sleeve assembly and contracts. In the second position the elastic claw extends out of the sleeve assembly and expands.

When the first end is pressed for the first time, the fixing unit is moved from the first position to the second position, and when the first end is pressed for the second time, the fixing unit is moved from the second position to the first position.

### BACKGROUND

1. Field of the Invention

The present invention relates to fixing units. The invention particularly relates to a fixing unit for joining two objects.

2. Description of Related Art

Screws and rivets are commonly used to join two objects. In using screws, a hand tool such as a screwdriver is needed, which can be inconvenient. In using rivets, a special tool is required and the rivets are not reusable.

### BRIEF DESCRIPTION OF THE DRAWINGS

FIG. 1 is an exploded, isometric view of a fixing unit in accordance with a first embodiment of the present invention, the fixing unit including a sleeve assembly;

FIG. 2 is an exploded, isometric view of the sleeve assembly of FIG. 1;

FIGS. 3 to 5 are assembled, cross-sectional views of the fixing unit of FIG. 1 and two objects, showing the fixing unit in different states; and

FIG. 6 is an assembled, cross-sectional view of a fixing unit in accordance with a second embodiment of the present invention, together with two objects.

### DETAILED DESCRIPTION

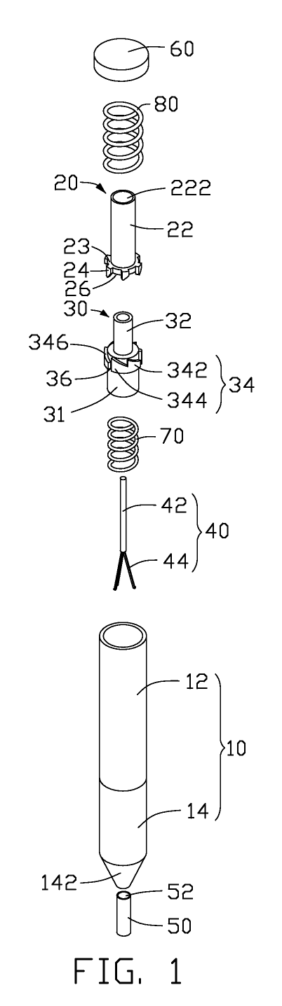

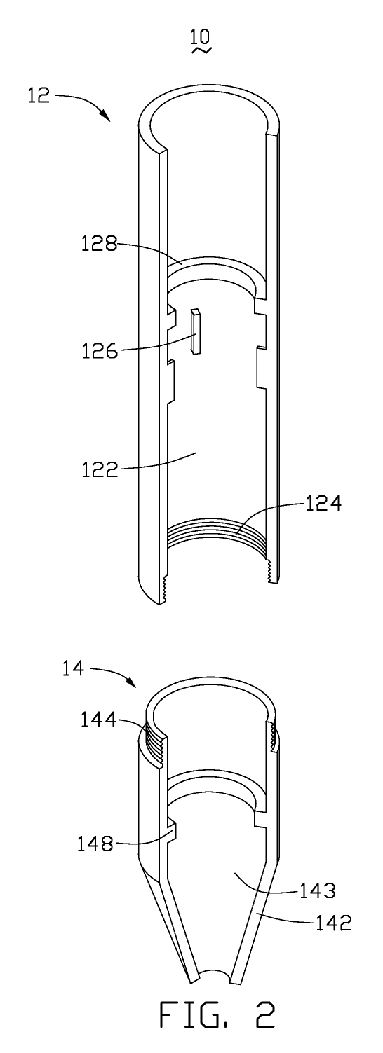

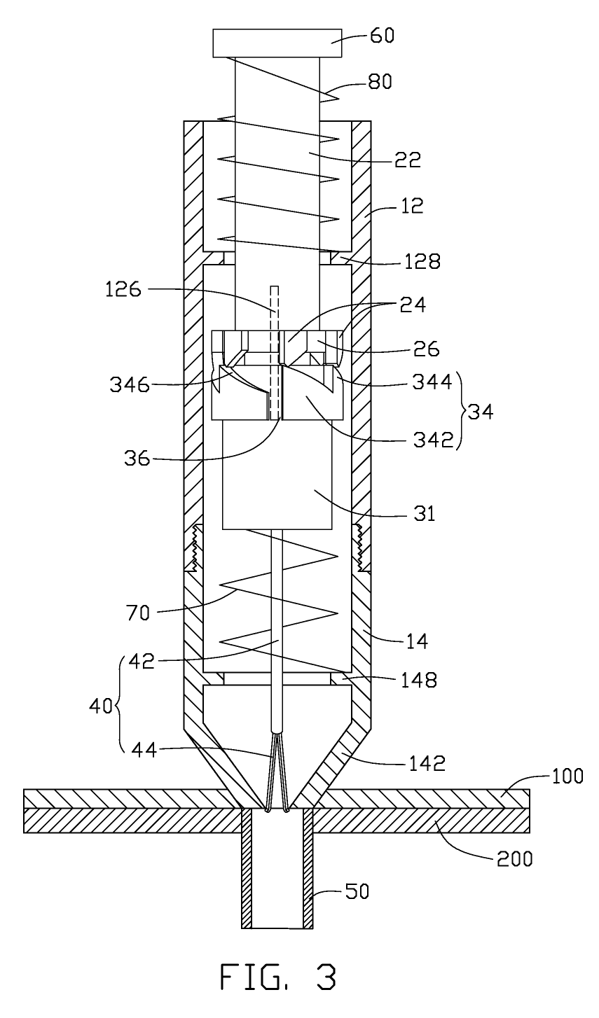

Referring to FIGS. 1 and 2, a fixing unit for joining two objects 100, 200 (see FIG. 3) each defining a mounting hole, is provided in accordance with an embodiment of the present invention. The fixing unit includes a sleeve assembly 10, a first engaging member 20, a second engaging member 30, a splaying member 40, an expandable member 50, an operating member 60, and two elastic members 70, 80.

The sleeve assembly 10 includes a first sleeve 12 and a second sleeve 14. The first sleeve 12 defines a through hole 122 along its axis. A thread portion 124 is formed at a lower portion of an inner wall bounding the through hole 122 of the first sleeve 12. A plurality of bar-shaped projections 126 axially extends from a middle portion of the inner wall of the first sleeve 12, and is equably located on the inner wall. A blocking ring 128 extends from a circumference of the inner wall of the first sleeve 12 over the projections 126. The second sleeve 14 defines a through hole 143 along its axis. A thread portion 144 is defined at an upper portion of an outer wall of the second sleeve 14. A lower portion of the second sleeve 14 gradually shrinks down to form a taper portion 142. A blocking ring 148 extends from a circumference of a middle portion of an inner wall bounding the through hole 143 of the second sleeve 14. The first sleeve 12 and the second sleeve 14 are coupled together via engagement of the thread portions 124,144.

The first engaging member 20 includes an rounded base 23, and a pushing pole 22 extending perpendicularly from a central portion of the rounded base 23. A plurality of teeth 24 extends from and is disposed equably along a circumference of the base 23. An engaging groove 26 is formed between every two adjacent teeth 24. The first engaging member 20 defines a through hole 222 along its axis.

The second engaging member 30 includes a pressing part 31, and a sliding pole 32 extending from an end of the pressing part 31. The pressing part 31 and the sliding pole 32 are columns along a same axis. The diameter of the pressing part 31 is greater than the diameter of the sliding pole 32. A teeth part is set on an upper portion of the pressing part 31. An assembly hole (not shown) is defined in a bottom of the pressing part 31. The teeth part includes a plurality of toothed assemblies 34. The toothed assemblies 34 extend from the pressing part 31 and are equably disposed along a circumference of the pressing part 31. Each of the toothed assemblies 34 includes a first tooth 342 and a second tooth 344, wherein the first tooth 342 and the second tooth 344 are connected end-to-end, and each includes a slanted driving surface 346 formed on the top thereof. An engaging groove 36 is formed between every two adjacent toothed assemblies 34.

The splaying member 40 includes a connecting shaft 42, and an elastic claw 44 made up of a plurality of fingers extending from an end of the shaft 42. The elastic claw 44 is expanded in its natural state.

The expandable member 50 is cylinder-shaped with a through hole 52 defined therein. The expandable member 50 is made of flexible materials.

The operating member 60 is discoid-shaped. An assembly hole (not shown) is defined in the bottom of the operating member 60.

The elastic members 70, 80 are coil springs.

Referring also to FIG. 3, in assembly, a free end of the shaft 42 of the splaying member 40 is operated to go through the tip of the taper portion 142 and into the through hole 143 of the second sleeve 14. Free ends of the fingers of the elastic claw 44 of the splaying member 40 just barely extend out of the tip of the taper portion 142. The elastic member 70 is received in the through hole 143 of the second sleeve 14 and coiled round the shaft 42 of the splaying member 40. The free end of the shaft 42 is mounted in the assembly hole in the bottom of the pressing part 31 of the second engaging member 30. Two ends of the elastic member 70 prop up the bottom of the pressing part 31 and the blocking ring 148 of the second sleeve 14 respectively. The sliding pole 32 of the second engaging member 30 is slid into the through hole 222 of the first engaging member 20 from the bottom, and the base 23 of first engaging member 20 is supported on the top of the pressing part 31 of the second engaging member 30. The first engaging member 20 together with the second engaging member 30 is received in the through hole 122 of the first sleeve 12. The first sleeve 12 and the second sleeve 14 are coupled together, while an adjustment is done to make the projections 126 of the first sleeve 12 be respectively received in some of the engaging grooves 26 of the first engaging member 20 and the engaging grooves 36 of the second engaging member 30. The elastic member 80 is received in the through hole 122 of the first sleeve 12 and coiled round the pushing pole 22 of the first engaging member 20. The top end of the pushing pole 22 of the first engaging member 20 is mounted in the assembly hole of the operating member 60. Two ends of the elastic member 80 prop up the operating member 60 and the blocking ring 128 of the first sleeve 12 respectively. The elastic member 80 urges the first engaging member 20 to rise a little, such that lower tips of the teeth 24 move to upper tips of the first teeth 342 and the second teeth 344 of the toothed assemblies 34 respectively; and the elastic claw 44 contracts as its retracted into the taper portion 142. The expandable member 50 is fixed to the tip of the taper portion 142 of the second sleeve 14 by any known method (for example, by sticking), wherein the through hole 52 of the expandable member 50 aligns with the through hole 143 of the second sleeve 14.

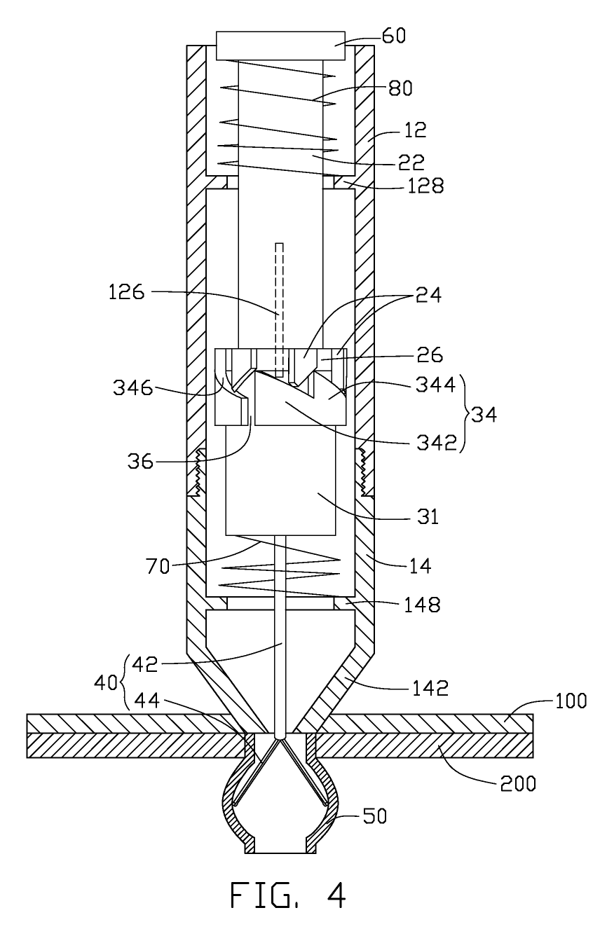

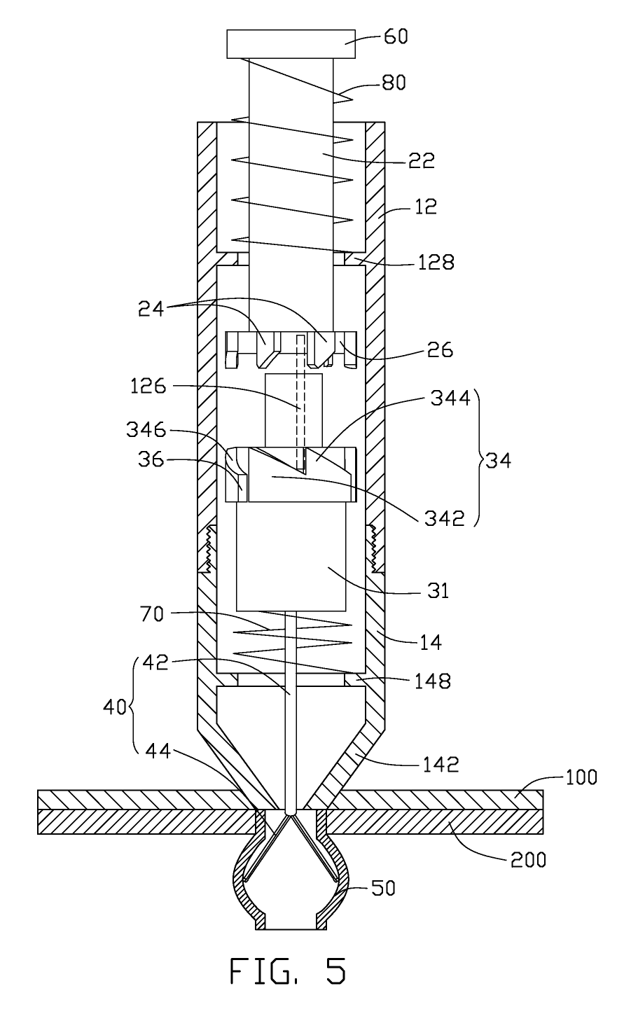

Referring also to FIGS. 4 and 5, in use, engagements among only one tooth 24, one toothed assembly 34, and one projection 126 will be described as an example hereinafter.

In using the fixing unit to join the objects 100, 200, firstly, the expandable member 50 is operated to go through the mounting holes of the objects 100, 200. Secondly, the operating member 60 together with the first engaging member 20 is pressed down. The second engaging member 30 is pushed by the first engaging member 20 to slide down along the projection 126 while the elastic members 70, 80 are compressed, and then rotated left after the top tip of the first tooth 342 passes over the lower end of the projection 126 because of the engagement between the lower tip of the tooth 24 and the slanted driving surface 346 of the first tooth 342, such that the projection 126 is located on the slanted driving surface 346 of the first tooth 342. The splaying member 40 is moved down. Thus, the elastic claw 44 extends out of the taper portion 142 of the second sleeve 14 and expands. The expandable member 50 is expanded by the expanded elastic claw 44. Lastly, the operating member 60 is released. Thus, the elastic member 70 is restored and makes the second and first engaging member 30, 20 rise up. The slanted driving surface 346 of the first tooth 342 engages with the lower end of the projection 126 due to the force of the elastic member 80 to make the second engaging member 30 rotate further, until the projection 126 abuts against a left side of the second tooth 344 of the toothed assembly 34 and cannot move any more. Thus, because the projection 126 engages with the second engaging member 30 preventing vertical movement thereof, the claw 44 is locked in its current extended position. The two objects 100, 200 are sandwiched and joined by the expanded expandable member 50 and the taper portion 142 of the second sleeve 14.

To separate the objects 100, 200, firstly, the operating member 60 is pressed down to drive the first engaging member 20 to slide down along the projection 126 accommodated in the engaging groove 26. The second engaging member 30 is pushed by the first engaging member 20 to move down, and rotated left after the top tip of the second tooth 344 passes over the lower end of the projection 126 because of the engagement between the lower tip of the tooth 24 and the slanted driving surface 346 of the second tooth 344. Secondly, the operating member 60 is released, such that the elastic member 70 is restored and makes the second and first engaging members 30, 20 to rise. The slanted driving surface 346 of the second tooth 344 engages with the lower end of the projection 126 due to the force of the elastic member 80, to make the second engaging member 30 rotate further until the lower end of the projection 126 falls into another engaging groove 36 next to the right side of the second tooth 344 of the toothed assembly 34. The elastic member 80 is restored and makes the first engaging member 20 move up along the projection 126. The elastic member 80 is restored further to make the second engaging member 30 together with the splaying member 40 rise, with the projection 126 accommodating in the another engaging groove 36. Thus, the claw 44 of the splaying member 40 contracts as its retracted back into the second sleeve 14 again, and the expandable member 50 restores to its natural state of contraction. The objects 100, 200 can be easily separated.

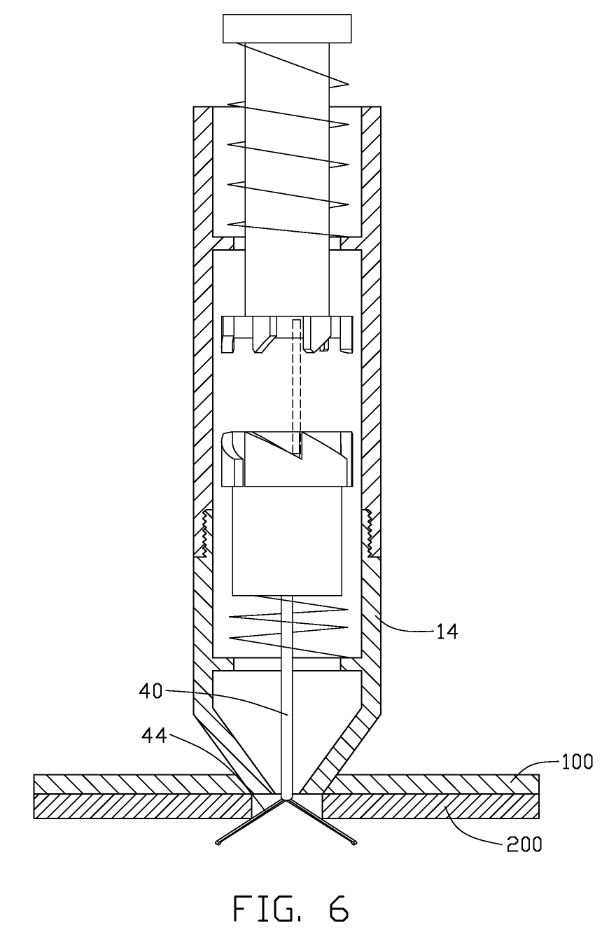

Referring to FIG. 6, in another embodiment of the present invention, the expandable member 50 is omitted, and the claw 44 of the splaying member 40 is directly used to join the objects 100, 200.

Certain applications will require more or less retention force by the fixing member. The fixing force of the invention can be adjusted by varying the elasticity of the elastic claw 44. This can be done by altering the size, shape and materials used for the claw 44.

It is believed that the present embodiments and their advantages will be understood from the foregoing description, and they will be apparent that various changes may be made thereto without departing from the spirit and scope of the invention or sacrificing all of its material advantages, the examples hereinbefore described merely being preferred or exemplary embodiments of the invention.

What is claimed is:

1. An apparatus comprising a fixing unit, the fixing unit comprising:
a sleeve assembly defining a through hole along an axis thereof and comprising a plurality of projections extending from an inner wall;
a first engaging member slidably received in the through hole, and comprising a plurality of teeth extending therefrom;
a second engaging member slidably received in the through hole and comprising a plurality of toothed assemblies, the toothed assemblies are configured to engage with the teeth; and
a splaying member slidably received in the through hole and mounted to the second engaging member, wherein the splaying member comprises an elastic claw extending therefrom, the elastic claw is biased towards an open state;
wherein the fixing unit has first and second position;
wherein in the first position, the elastic claw is received in the sleeve assembly and is in a contracted state; in the second position the elastic claw extends out of the sleeve assembly and is in an expanded state;
wherein when the fixing unit is moved from the first to the second position, the first engaging member moves the second engaging member; the second engaging member moves the splaying member and the elastic claw of the splaying member extends out of the sleeve assembly and expands; the teeth engage the toothed assemblies; the second engaging member rotates; and the toothed assemblies engage with the projections.

2. The apparatus as claimed in claim 1, wherein the fixing unit further comprises an expandable member extending from the sleeve assembly, a hole is defined in the expandable member communicating and aligning with the through hole, the expandable member is capable of being expanded by the expanded elastic claw.

3. The apparatus as claimed in claim 2, wherein the expandable member is made of flexible materials.

4. The apparatus as claimed in claim 3, wherein the fixing unit further comprises a first elastic member received in the through hole, the first elastic member is configured to biases the second engaging member against the first engaging member.

5. The apparatus as claimed in claim 4, wherein the first elastic member is a coil spring, the sleeve assembly comprises a blocking ring, the spring acts against the second engaging member and the blocking ring.

6. The apparatus as claimed in claim 4, wherein the fixing unit further comprises a second elastic member received in the through hole, the second elastic member is configured to bias the first engaging member away from the second engaging member.

7. The apparatus as claimed in claim 6, wherein the fixing unit further comprises an operating member, the operating member is fixed to a first end of the first engaging member, the operating member is exposed.

8. The apparatus as claimed in claim 7, wherein the second elastic member is a coil spring, the sleeve assembly comprises a blocking ring, the spring acts against the operating member and the blocking ring.

9. The apparatus as claimed in claim 1, wherein
the projections are bar-shaped and parallelly disposed along a circumference of the inner wall;
the second engaging member further comprises a pressing part connected with the splaying member, the toothed assemblies extends from the pressing part and disposed along a circumference of the pressing part, an engaging groove is formed between every two adjacent toothed assemblies;
wherein in the first position each of the projections of the sleeve assembly are at least partly received in one engaging groove.

10. The apparatus as claimed in claim 9, wherein each of the toothed assemblies comprises a first tooth, and a second tooth connecting to the first tooth; each of the first tooth and the second tooth defines a slanted driving surface.

11. The apparatus as claimed in claim 1, wherein the sleeve assembly comprises a first sleeve and a second sleeve, the second sleeve is capable of disengaging from the first sleeve.

12. An apparatus comprising a fixing unit, the fixing unit comprising:
a sleeve assembly defining a through hole along an axis thereof; and
an assembly slidably received in the through hole, wherein the assembly comprises a first end and a second end; an elastic claw extends from the second end, the first end is capable of being pressed, the elastic claw is biased towards an open state;
wherein the fixing unit has first and second position;
wherein in the first position, the elastic claw is received in the sleeve assembly and is in a contracted state; in the second position the elastic claw extends out of the sleeve assembly and is in an expanded state;
wherein upon a condition that the first end is pressed for the first time, the fixing unit is capable of being actuated from the first position to the second position, and upon a condition that the first end is pressed for the second time, the fixing unit is capable of being actuated from the second position to the first position.

13. The apparatus as claimed in claim 12, wherein the fixing unit further comprises an expandable member extending from the sleeve assembly; a hole is defined in the expandable member, the hole communicates and aligns with the through hole of the sleeve assembly; the expandable member is expanded in the second position.

14. The apparatus as claimed in claim 12, wherein
the sleeve assembly comprises a plurality of projections extending from an inner wall;
the assembly comprises a first engaging member and a second engaging member; the first end is set on the first engaging member, the second end is set on the second engaging member; the first engaging member comprises a plurality of teeth extending therefrom; the second engaging member comprises a plurality of toothed assemblies, the toothed assemblies are configured to engage with the teeth;
wherein when the fixing unit is moved from the first to the second position, the first engaging member moves the second engaging member; the second engaging member moves the elastic claw out of the sleeve assembly and the elastic claw expands; the teeth engage the toothed assemblies; the second engaging member rotates; and the toothed assemblies engage with the projections.

15. The apparatus as claimed in claim 14, wherein the fixing unit further comprises a first elastic member received in the through hole, the first elastic member biases the second engaging member against the first engaging member.

16. The apparatus as claimed in claim 15, wherein the first elastic member is a coil spring, the sleeve assembly comprises a blocking ring, the spring acts against the second engaging member and the blocking ring.

17. The apparatus as claimed in claim 15, wherein the fixing unit further comprises a second elastic member received in the through hole, the second elastic member biases the first engaging member away from the second engaging member.

18. The apparatus as claimed in claim 17, wherein the fixing unit further comprises an operating member, the operating member is fixed to the first end; the second elastic member is a coil spring, the sleeve assembly comprises a blocking ring, the spring acts against the operating member and the blocking ring.

19. The apparatus as claimed in claim 14, wherein
the projections are bar-shaped and arranged in parallel along a circumference of the inner wall;
the second engaging member further comprises a pressing part connected with the elastic claw, the toothed assemblies extends from the pressing part and are disposed along a circumference of the pressing part, an engaging groove is formed between every two adjacent toothed assemblies;
wherein in the first position each of the projections of the sleeve assembly are at least partly received in one engaging groove.

20. The apparatus as claimed in claim 19, wherein each of the toothed assemblies comprises a first tooth, and a second tooth connecting to the first tooth; each of the first tooth and the second tooth defines a slanted driving surface.
